(19) United States
(12) Patent Application Publication
(10) Pub. No.: US 2006/0227998 A1
(43) Pub. Date: Oct. 12, 2006

(54) Method for using networked programmable fiducials for motion tracking

(76) Inventors: Andrew Wesley Hobgood, Nashua, NH (US); John Franklin Ebersole JR., Bedford, NH (US)

Correspondence Address: Brian M. Dingman, Esq.;Mirick, O'Connell, DeMallie & Lougee, LLP, 1700 West Park Drive, Westborough, MA, 01581, US

(21) Appl. No.: 11/092,084

(22) Filed: Mar. 29, 2005

(51) Int. Cl. G06K 9/00

(52) U.S. Cl. 382/103

(57) ABSTRACT

A method and system for motion tracking for an object and obtaining high-resolution, fast, and low latency position and orientation information for that object that is globally registered in a large environment. Networked, programmable fiducials are distributed through the area within which high accuracy tracking is desired. A high-resolution local tracking method is processed by the object tracking computer. The fiducials gather information from an environmental coordinate system (such as GPS) and communicate with the object tracking computer to register the high-resolution local tracking area to the global environment. The result is dramatically reduced setup and calibration of the system, as well as high-resolution, low latency global tracking information which enables highly demanding applications, such as head-mounted augmented reality (AR) with geographical information overlay.

### FIELD OF THE INVENTION

The invention relates to tracking the global position and orientation of objects, including use in augmented reality applications.

### COPYRIGHT INFORMATION

A portion of the disclosure of this patent document contains material that is subject to copyright protection. The copyright owner has no objection to the facsimile reproduction by anyone of the patent document or the patent disclosure as it appears in the Patent and Trademark Office records but otherwise reserves all copyright works whatsoever.

### BACKGROUND OF THE INVENTION

When high accuracy, high speed information about the position and orientation of an object within a particular area is required for an application (such as augmented reality [AR] or virtual reality [VR]), tracking systems are often installed throughout the location in which the object will be moving. These systems (such as the InterSense IS-900, 3rdTech HiBall, or Polhemus FASTRAK) often require a labor-intensive calibration phase whenever the system is relocated. These systems may also have poor fault tolerance, line-of-sight restrictions, limited range, and poor weatherproofing. These systems are typically registered to a local coordinate system, and are thus normally bound to a specific room or building. As a result, the tracked object position is only meaningful within that local coordinate system.

These limitations make existing tracking technologies difficult or impossible to use outdoors or in complex indoor environments (such as machinery rooms, multi-level environments, or entire buildings). These technologies also make mobile training environments difficult, as the position of information requiring wide-area environmental registration (such as GIS or meteorological data) shares no commonality with the local coordinate frame of the tracking system.

### SUMMARY OF THE INVENTION

This invention provides a method for using networked, programmable fiducials that can be placed around the area in which an object that needs to be tracked is going to be moving, and can provide seamless integration of lower resolution, relatively slow environmental tracking information (such as GPS data) with high resolution, high speed local tracking information (from any suitable tracking system), resulting in high resolution, high speed environmental tracking for the object.

This invention can be used any time a user needs to track an object (e.g. a user's head in an AR or VR application) accurately and with high temporal resolution (refresh rate) within a large environment with minimal calibration and setup. By combining information from multiple sensors, the user can obtain high resolution, high speed localized tracking data suitable for demanding applications (such as head-mounted augmented reality), while maintaining the flexibility, mobility, and simplicity of environmental tracking systems (such as Global Positioning System [GPS]). By utilizing existing environmental tracking infrastructure, calibration time can be reduced dramatically when compared against other local tracking techniques. Also, as this high-resolution tracking data is environmentally registered, other data (such as map information, geographical information systems [GIS] data, and global meteorological data) can be represented seamlessly within the same space as the object being tracked, offering seamless local representation of environmental data.

This invention features a method for tracking an object moving within an environment, comprising providing one or more networked fiducials in the environment, providing an object tracking computer, detecting the presence of the fiducials in the environment, identifying each fiducial uniquely from others in the environment, determining the location of the fiducials relative to the object, resolving the location of the fiducials within a fixed environmental coordinate frame, communicating the resolved location of the fiducials within the fixed environmental coordinate frame to the object tracking computer, and using the computer to compute the position of the object within the environmental coordinate frame.

The detecting step may comprise using a passive detection system or an active detection system. The identifying step may comprise using a passive identification system or an active identification system. The method of claim 1 wherein the determining step may comprise determining both the position and orientation of the fiducial within the object's coordinate frame. The determining step may comprise determining only the position and not the orientation of the fiducial within the object's coordinate frame. Three or more fiducials may be provided, and the determining step may determine the location of at least three fiducials.

The determining step may comprise using an assisted or an unassisted technique to find the location of the fiducial within the object's coordinate frame. The fiducials may be at fixed or variable locations in the environment, or may initially be at variable locations, and then at fixed locations. The communicating step may employ a tethered communications system or an untethered, wireless communications system.

Also featured is a system for tracking an object moving within an environment, comprising one or more networked fiducials located in the environment, a video camera coupled to the object, an object tracking computer in communication with the video camera and the fiducials, means for resolving the environmental locations of the fiducials, means for determining the location of the object relative to at least the fiducials, and means, responsive to the means for resolving and the means for determining, for calculating the location of the object in the environment.

### BRIEF DESCRIPTION OF THE DRAWINGS

Other objects, features and advantages will occur to those skilled in the art from the following description of the preferred embodiments and the accompanying drawings in which:

FIG. 1 shows the exterior view of one of the fiducials for the preferred embodiment of the invention;

FIG. 2 is a schematic representation of an exemplary frame from a video stream, useful in illustrating the invention;

FIG. 3 is a block diagram of the fiducial of FIG. 1;

FIG. 4 is a block diagram of the object tracking station for the preferred embodiment of the invention; and

FIG. 5 shows a collection of interest points and fiducial locations, useful for understanding the invention.

### DETAILED DESCRIPTION OF THE PREFERRED EMBODIMENTS OF THE INVENTION

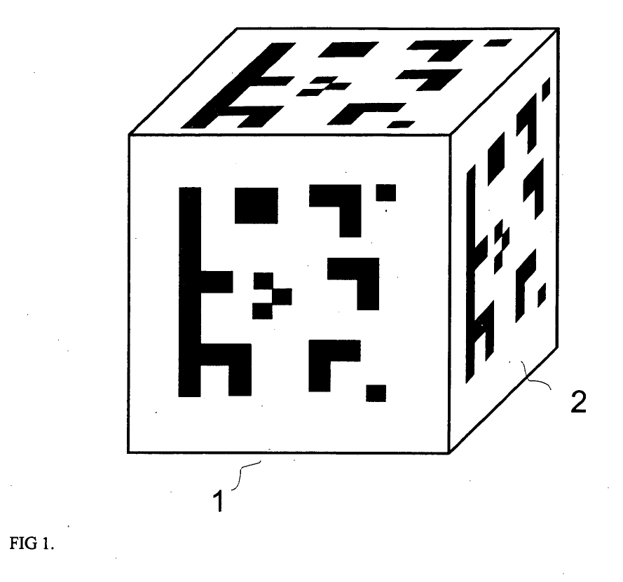

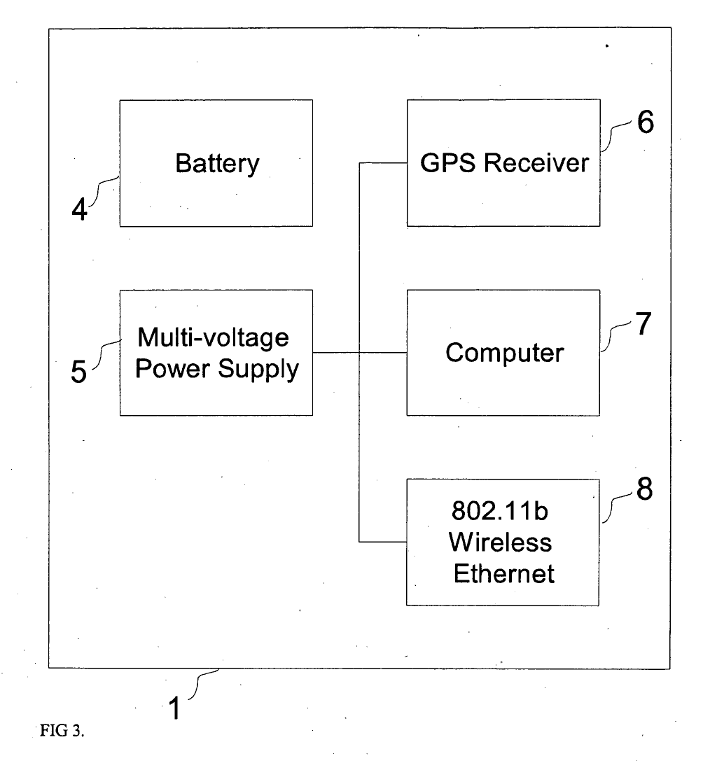

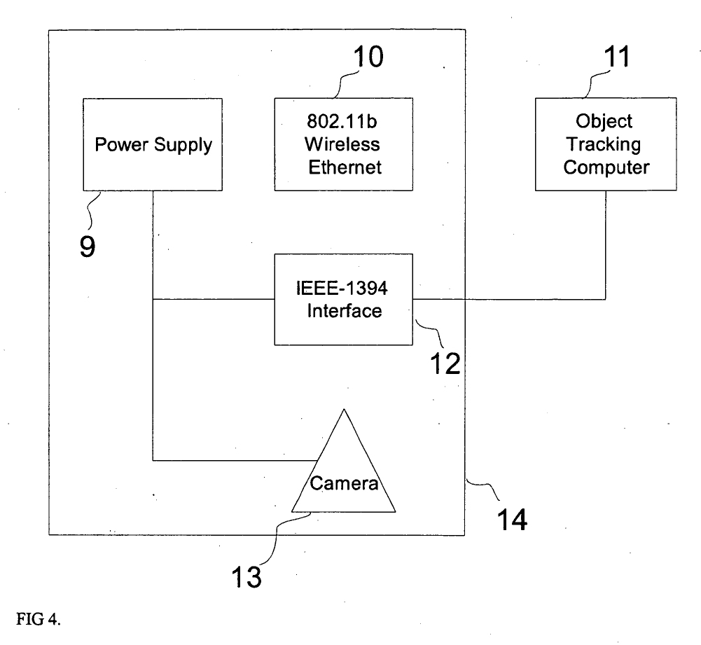

The preferred embodiment of the invention is comprised of at least one networked, programmable fiducial and an object tracking station with associated tracking computer. The exterior view of one of the fiducials is provided in FIG. 1. A block diagram of the fiducial is provided in FIG. 3, and a block diagram of the object tracking station is provided in FIG. 4.

Each fiducial (1) is comprised of a differential GPS (DGPS) receiver (6) for environmental tracking, standard 802.11b wireless Ethernet networking hardware (8) for communication, an embedded computer (7) for computation, and a rechargeable battery (4) and multi-voltage power supply (5) to provide power for fiducial components. The fiducial hardware all fits in a small, weather-resistant case, which is marked on all sides with unique printed black and white patterns (2). The patterns allow each fiducial to be visually recognized and identified uniquely from any others in the environment.

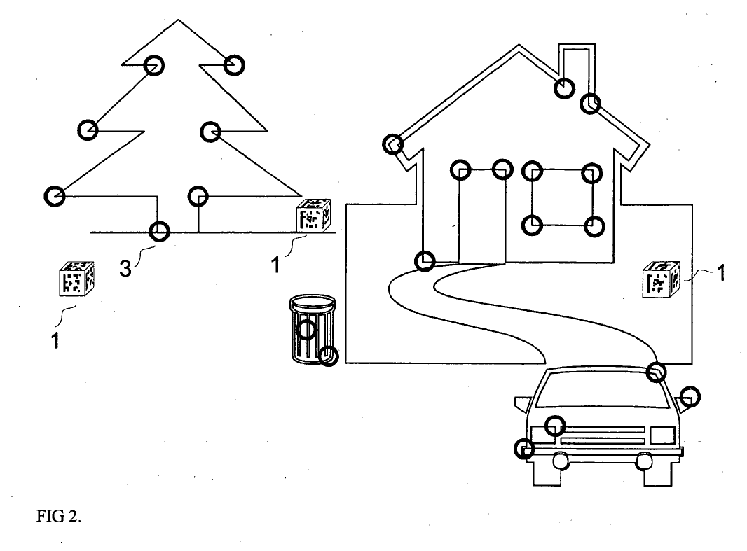

The object tracking station (14) and tracking computer (11) consist of a small video camera (13) attached to the object and an IEEE-1394/FireWire interface (12) connecting the camera to the tracking computer. The tracking computer runs a computer-vision based hybrid tracking algorithm, including automated environmental feature detection (which finds and locates ad-hoc “interest points” (3) in the environment [shown as circles in FIG. 2] to aid in high-resolution tracking) as well as fiducial recognition algorithms.

During initialization of the tracking system, the tracking computer 11 begins to process video frames arriving in real time, from the video camera 13 that is attached to the tracked object. An exemplary frame from such a video stream is shown in FIG. 2.

Using algorithms known in the art, computer 11 detects, identifies, and locates so-called “interest points” (3) in the environment. The interest points are areas of the video frame that show high contrast, edges, unique patterns, or other features that make them uniquely detectable. These interest points tend to be consistently recognizable at a wide range of distances, orientations, and lighting conditions. The computer vision algorithm can store the locations of the interest points and use them to calculate its own position relative to interest points 3 within the immediate area. One benefit of the invention is that only a relatively small number of fiducials are needed, but using a lot of interest points is inexpensive (the environment provides them), and yet allows high spatial resolution due to the large number of interest points that can be used.

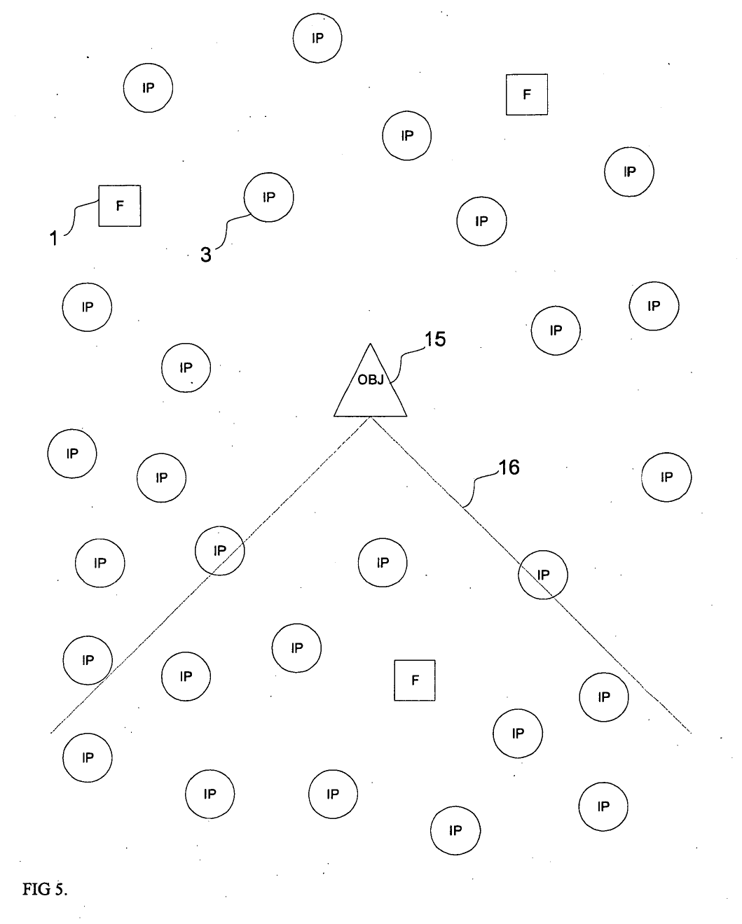

Computer 11 also detects, identifies, and locates the networked programmable fiducials (1) in the environment. The computer vision algorithm can calculate the locations of the fiducials relative to the interest points that have been stored since the system was initialized. A collection of interest points (labeled “IP) and fiducial locations (labeled “F”) is shown in FIG. 5. While the object and the attached camera move, the locations of interest points (3) and fiducials (1) relative to the camera (15) are constantly updated. As a result, the position and orientation of the object relative to the fixed interest points and fiducials is constantly calculated. Similarly, as the camera moves throughout the environment, it analyzes video from its field of view (16) and continues to detect new interest points, or the presence of new fiducials. Algorithms to achieve this (such as Extended Kalman filters) are well known in the art of object tracking.

Meanwhile, the networked programmable fiducials query the environmental tracking system. Each fiducial is programmed with software that permits the embedded computer to perform operations with the other hardware in the fiducial, as well as process information and send it over the wireless network. In this case, a differential GPS unit (6) using WAAS (Wide Area Augmentation System) reference obtains global position data accurate to approximately one meter. The fiducial then broadcasts this position to any tracking computers and other fiducials in the environment via the wireless network (8), along with a unique fiducial identification number that is matched to the uniquely recognizable printed patterns on the sides of the fiducial case.

The tracking computer (11), upon detecting and identifying a fiducial in its tracking area, can then take the most recent update it has received over the wireless network (10) from that fiducial and record the fiducial's global position. By using the known local and global coordinates of the fiducials, a transformation matrix can be calculated by using algorithms well known in the art that permits projection of the local camera position into the global coordinate space. This permits the global position of the camera to be determined.

If, while the system is operating, the fiducials move through the environment (such as if they are attached to a moving vehicle), the system will continue to operate effectively. Since the fiducials are constantly receiving updates from the GPS environment, and broadcasting that information over the wireless network, the tracking computer is always aware of the most recent valid GPS information for the fiducials, as well as the most recent valid positions of the fiducials within the local coordinate frame. This permits enhanced mobility with no user intervention required.

The advantage of this system is that it can provide very accurate, high-speed, globally registered position and orientation data that is otherwise unavailable. Differential GPS, even utilizing advanced augmentation algorithms and references such as WAAS or RTK (real-time kinematic) GPS, can only measure position at a coarse resolution, and with relatively slow update rates. Passive optical tracking with interest point algorithms can provide very high resolution position and orientation data, at very fast update rates, but the position and orientation data exists within an arbitrary coordinate frame that must be calibrated and registered to the global coordinate frame in order to use global data. The invention provides an automated, seamless, mobile method to calibrate and register the local coordinate frame to the global coordinate frame, and provide much higher resolution and update rates than differential GPS solutions alone.

In the preferred embodiment of the invention, the environment is defined as the Earth, and the environmental coordinate frame is a geographical one, consisting of latitude, longitude, altitude, heading, pitch, and roll. Alternatively, other embodiments of the invention could define the environment as a smaller one, such as throughout a building, and use an appropriate environmental tracking system for such an area.

Also, positions of fiducials within the environmental coordinate frame may also be fixed to a constant value, rather than being constantly updated by an environmental tracking system. In a scenario where surveying or other direct measurement technique is available to find the location of a fiducial, the fiducial can be programmed to always report that fixed location to a tracking computer. This permits the system to operate in an environment where an environmental tracking system (such as GPS) is unavailable or highly inaccurate.

In environments where the environmental tracking system is subject to erratic reporting, the fiducial may also gather updates from the environmental tracking system until a previously determined degree of accuracy can be guaranteed. Once this accuracy threshold has been achieved, the fiducial can lock that value, and report it as a constant value. This prevents the system from drifting if the environmental tracking system becomes unreliable.

Techniques for detecting and uniquely identifying the fiducials in the environment can be achieved by any one of a number of means, including passive and active techniques. Passive approaches include unique markings on the fiducial that are processed by a camera, such as in the preferred embodiment. Active approaches can be optical (such as an LED blinking in a particular pattern that is detected by a photodiode), acoustic (using ultrasonic pulses detected by a microphone), or electromagnetic (by using electromagnetic pulse patterns that are detected by a coil of wire or antenna). Usually, the detection and identification of a fiducial will use the same technique and occur simultaneously, but this is not necessarily the case.

Many techniques exist for measuring the locations of the fiducials relative to the object being tracked. Measuring the location of a fiducial relative to the object can be accomplished with either an unassisted method (using calculations that occur solely on the object tracking computer with no additional tracking reference, such as in the preferred embodiment), or an assisted method (where the object and the fiducials participate in a secondary tracking environment). Assisted techniques can utilize any standard local-area tracking system, such as the InterSense IS-900, 3rdTech Hi-Ball, or Polhemus FASTRAK.

The location of a fiducial in the object coordinate frame can include position and orientation data. Sometimes, orientation information is difficult to obtain (such as when a fiducial is small or partially occluded) or is unreliable. As such, in those situations, the invention can operate with position data only. Ideally, to obtain optimal registration and tracking performance, three or more fiducials would be available at any given time, such as to provide a good basis for triangulation of object position without requiring fiducial orientation.

Finally, the means for communication between the fiducials and the tracking computer can be provided in many ways. A tethered system can be used in environments where interference is high or where emissions are not permissible. An untethered system, such as radio (such as 802.11b wireless Ethernet or BlueTooth), infrared (IRDA), acoustic, or electromagnetic encoding can permit fiducials to exchange information with one another and the tracking computer over some distance.

Other embodiments will occur to those skilled in the art and are within the following claims.

What is claimed is:

1. A method for tracking an object moving within an environment, comprising:
providing one or more networked fiducials in the environment;
providing an object tracking computer;
detecting the presence of the fiducials in the environment;
identifying each fiducial uniquely from others in the environment;
determining the location of the fiducials relative to the object;
resolving the location of the fiducials within a fixed environmental coordinate frame;
communicating the resolved location of the fiducials within the fixed environmental coordinate frame to the object tracking computer; and
using the computer to compute the position of the object within the environmental coordinate frame.

2. The method of claim 1 wherein the detecting step comprises using a passive detection system.

3. The method of claim 1 wherein the detecting step comprises using an active detection system.

4. The method of claim 1 wherein the identifying step comprises using a passive identification system.

5. The method of claim 1 wherein the identifying step comprises using an active identification system.

6. The method of claim 1 wherein the determining step comprises determining both the position and orientation of the fiducial within the object's coordinate frame.

7. The method of claim 1 wherein the determining step comprises determining only the position and not the orientation of the fiducial within the object's coordinate frame.

8. The method of claim 7 wherein three or more fiducials are provided, and the determining step determines the location of at least three fiducials.

9. The method of claim 1 wherein the determining step comprises using an unassisted technique to find the location of the fiducial within the object's coordinate frame.

10. The method of claim 1 wherein the determining step comprises using an assisted technique to find the location of the fiducial within the object's coordinate frame.

11. The method of claim 1 wherein the fiducials are at fixed locations in the environment.

12. The method of claim 1 wherein the fiducials are at variable locations in the environment.

13. The method of claim 1 wherein the fiducials are initially at variable locations, and then are at fixed locations.

14. The method of claim 1 wherein the communicating step employs a tethered communications system.

15. The method of claim 1 wherein the communicating step employs an untethered, wireless communications system.

16. A system for tracking an object moving within an environment, comprising:
one or more networked fiducials located in the environment;
a video camera coupled to the object;
an object tracking computer in communication with the video camera and the fiducials;
means for resolving the environmental locations of the fiducials;
means for determining the location of the object relative to at least the fiducials; and
means, responsive to the means for resolving and the means for determining, for calculating the location of the object in the environment.
